(19) United States
(12) Patent Application Publication
(10) Pub. No.: US 2018/0334571 A1
(43) Pub. Date: Nov. 22, 2018

(54) WATER REPELLENT COMBINATIONS

(71) Applicant: Janssen Pharmaceutica NV, Beerse (BE)

(72) Inventors: Pradip Kumar Mookerjee, Flemington, NJ (US); Venugopal Govindegowda, Mandya (IN); Sreenivasa Rao Damarla, Bangalore (IN)

(73) Assignee: Janssen Pharmaceutica NV, Beerse (BE)

(21) Appl. No.: 15/757,864

(22) PCT Filed: Sep. 5, 2016
(86) PCT No.: PCT/EP2016/070828

§ 371 Date: Mar. 6, 2018

(30) Foreign Application Priority Data
Sep. 7, 2015 (IN) 3437/MUM/2015
Jan. 21, 2016 (EP) 16152204.0

(51) Int. Cl. C09D 5/00; D21H 21/16; D21H 17/17; D21H 17/12; D21H 17/00; C04B 41/62; C04B 41/82; C04B 41/46; C04B 41/00; C14C 11/00; D06M 13/03; B05D 7/06

(52) U.S. Cl. CPC C09D 5/00; D21H 21/16; D21H 17/17; D21H 17/12; D21H 17/72; B05D 7/06; C04B 41/82; C04B 41/46; C04B 41/009; C14C 11/00; D06M 13/03; C04B 41/62

(57) ABSTRACT

The present invention concerns combinations of a water repellent alkyl ketene dimer as a component (I) and a water repellent metal alcoholate as a component (II) that are strongly synergistic in repelling water from water absorbing surfaces, resulting in a surprisingly long water droplet absorption time. The combinations of the invention can be applied to the surface of any material that has water absorbing properties such as, but not limited to, wood, woven and non-woven sheeting materials, paper, building materials, gypsum board, and leather.

The present invention concerns combinations of a water repellent alkyl ketene dimer as a component (I) and a water repellent metal alcoholate as a component (II) that are strongly synergistic in repelling water from water absorbing surfaces, resulting in a surprisingly long water droplet absorption time. The combinations of the invention can be applied to the surface of any material that has water absorbing properties such as, but not limited to, wood, woven and non-woven sheeting materials, paper, building materials, gypsum board, and leather.

Wood products used in the home and in industry often have to be rendered hydrophobic while retaining a wood appearance, for example in interior uses in kitchens and bathrooms, and in particular, in outdoor uses such as wooden decks, pergolas, gazebos, aesthetic architectural elements, tables, chairs, and the like. Wood is subject to severe biological degradation and photo degradation. Moist wood, in particular, is easily subject to disfigurement and attack through growth of molds, fungi, lichens, and moss.

The main components of wood are cellulose, hemicellulose and lignin. The cellulose and hemicellulose contain hydrophilic structures which are mainly hydroxyl groups. The hydroxyl groups have the ability to interact with water molecules to form hydrogen bonds. Wood is capable of absorbing as much as 100% of its weight in water which causes the wood to swell. Water loss through evaporation results in wood shrinking. This natural water absorption/evaporation process is non-uniform which creates internal stresses in the wood. These internal stresses cause the wood to check, split and warp when exposed to aqueous fluids and high humidity environments.

There are several approaches to improve water-repellency and dimensional stability of wood, including immersion-diffusion or vacuum-impregnation with preservatives, heating, brushing paint, and surface coating. One emerging technique is chemical modification, where chemicals such as anhydrides, isocyanates, alkyl chlorides, etc., react with hydroxyl groups, i.e., with the most reactive groups of cell wall polymers. For economic reasons and for simplicity, surface coating has long been preferred to chemical modifications for making wood hydrophobic.

The primary function of any coating is to prevent moisture penetration, improve resistance to weathering, and maintain the natural appearance of wood. The use of waxes, oils, polymers, and siloxanes are well known in the prior art. However, deficiencies in durability and degree of hydrophobicity have fostered a search for substances and compositions that yield better performance in imparting water resistance properties to wood.

The compositions of this invention are highly synergistic combinations of an alkyl ketene dimer (AKD) with a metal alcoholate. Preferred metal alcoholates are tributyl orthotitanate (TBOT), aluminum isopropoxide (AIP), copper isopropoxide (CIP), and zirconium propoxide (ZNP).

### PRIOR ART

U.S. Pat. No. 8,632,659 discloses the use of paper sizing compositions comprising a dispersion of alkyl ketene dimer and a pH adjusted vinylamine containing polymer.

US-2009/0304939 discloses a method of protecting wood using an aqueous dispersion of alkyl ketene dimer applied onto the surface of wood making the surface become hydrophobic and the contact angle of water in the form of drops on the treated wooden surface to exceed 100°.

WO-2005/009700 discloses a method for treating thermally modified wood, wherein a piece of the thermally modified wood is made water repellent by treating it with a hydrophobic sizing agent, which is absorbed into the wood and which is reactive with cellulose, the sizing agent being an alkyl ketene dimer (AKD).

U.S. Pat. No. 2,628,171 and U.S. Pat. No. 3,083,114 disclose that combining titanates with paraffin wax yields hydrocarbon soluble compositions that have utility in imparting water repellency to textile fabrics.

US RE 23,879 discloses compositions that are used to impregnate leather and make it water repellent. These compositions comprise polysiloxanes and titanates, preferably TBOT.

EP-0,436,327 discloses a water- and oil-repellent treating agent for fibrous substrates comprising a fluorochemical type water- and oil-repellent agent, a carbodiimide compound, and at least one component selected from the group consisting of plasticizer, an aluminum zirconium, or titanium metal ester or alcoholate, aziridine, zirconium salt, alkyl ketene dimer, alkenyl succinic anhydride.

### DESCRIPTION OF THE INVENTION

It has been found, surprisingly, that combinations of water repellent alkyl ketene dimers (AKD's) and water repellent metal alcoholates act synergistic in repelling water from water absorbing materials, resulting in a surprisingly increased water droplet absorption time. Such combinations address the need for effective and economical water repellents for use in the treatment of water absorbing materials that are based on green chemistry and also enable the minimization or avoidance of toxic biocide usage that is needed when these materials are not adequately protected from incursion of water.

“Alkyl ketene dimers”, i.e. AKD's, are wax-like additives which are commonly used in hydrophobing paper and cardboard. The AKD's comprise a lactone ring, to which two hydrocarbon chains are attached by means of chemical bonds, the carbon chain length of which varies typically between C6-C40. Typically, the carbon chains are straight-chained and saturated, but there are also commercial products in which the carbon chain is branched and/or unsaturated. The hydrocarbon groups of AKD comprise especially approximately 6-40 carbon atoms, in which case particularly common are those which comprise 12-20 carbon atoms. Typical hydrocarbon groups are the hexadecyl and/or octadecyl groups. The water repellent AKD's can be represented by the following Markush formula:

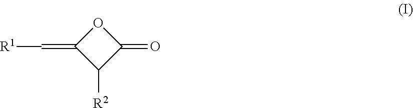

wherein R¹ and R² are each independently selected from C₃₋₄₀alkyl and C₃₋₄₀alkenyl. The AKD's are also referred to as a component (I).

Exemplary water repellent AKD's are e.g. 2-hexadecyl-3-hydroxy-3-eicosenoic acid, β-lactone; cetylketene dimer; hexadecylketene dimer, palmitylketene dimer, myristylketene dimer, tetradecylketene dimer, isostearyl ketene dimer, 4-(8Z)-8-heptadecen-1-ylidene-3-(7Z)-7-hexadecen-1-yl-2-oxetanone, 4-(8-heptadecenylidene)-3-(7-hexadecenyl)-2-oxetanone, 4-(8Z)-8-ineptadecenylidene-3-(7Z)-7-hexadecenyl-2-oxetanone, oleic ketene dimer, 4-butylidene-3-propyl-2-oxetanone, 3-butyl-4-pentylidene-2-oxetanone, 4-hexylidene-3-pentyl 2-oxetanone, 4-heptylidene-3-hexyl 2-oxetanone, 4-(5-hexen-1-ylidene)-3-(4-penten-1-yl)-2-oxetanone, 3-heptyl-4-octylidene-2-oxetanone, 4-nonylidene-3-octyl-2-oxetanone, 4-(nonenylidene)-3-(octenyl)-2-oxetanone, 4-decylidene-3-nonyl-2-oxetanone, 4-(decen-1-ylidene)-3-(nonen-1-yl)-2-oxetanone, 3-decyl-4-undecylidene-2-oxetanone, 3-decyl-4-dodecylidene-2-oxetanone, 4-(9-decen-1-ylidene)-3-(8-nonen-yl)-2-oxetanone, 3-dodecyl-4-tridecylidene-2-oxetanone, 3-(9-decen-1-yl)-4-(10-undecen-1-ylidene)-2-oxetanone, 3-dodecyl-4-tetradecylidene-2-oxetanone, 4-pentadecylidene-3-tetradecyl-2-oxetanone, 3-hexadecyl-4-undecylidene-2-oxetanone, 4-(pentadecenylidene)-3-(tetradecenyl)-2-oxetanone, 4-heptadecylidene-3-tetradecyl-2-oxetanone, 3-hexadecyl-4-pentadecylidene-2-oxetanone, 4-hexadecylidene-3-tetradecyl-2-oxetanone, 4-heptadecylidene-3-hexadecyl-2-oxetanone, 3-hexadecyl-4-hexadecylidene-2-oxetanone, 4-(heptadecenylidene)-3-(hexadecenyl)-2-oxetanone, 3-hexadecyl-4-octadecylidene-2-oxetanone, 3-heptadecyl-4-octadecylidene-2-oxetanone, 4-nonadecylidene-3-octadecyl-2-oxetanone, 3-eicosyl-4-heneicosylidene-2-oxetanone, 4-(nonadecenylidene)-3-(octadecenyl)-2-oxetanone, 3-hexadecyl-4-tricosylidene-2-oxetanone, 3-(eicosenyl)-4-(heneicosenylidene)-2-oxetanone, 4-docosylidene-3-heneicosyl-2-oxetanone, 4-eicosylidene-3-octadecyl-2-oxetanone, 4-docosylidene-3-eicosyl-2-oxetanone, 3-docosyl-4-tricosylidene-2-oxetanone, 4-hentriacontylidene-3-triacontyl-2-oxetanone, 4-heptacosylidene-3-hexacosyl-2-oxetanone, 4-(15-methyl-hexadecylidene)-3-(14-methylpentadecyl)-2-oxetanone, 3-dotriacontyl-4-tritriacontylidene-2-oxetanone, 4-(15-methoxpentadecylidene)-3-(14-methoxytetradecyl)-2-oxetanone, 4-(10Z)-10-nonadecen-1-ylidene-3-(9Z)-9-octadecen-1-yl-2-oxetanone, 4-(16-methoxy-hexadecylidene)-3-(15-methoxypentadecyl)-2-oxetanone, 3-(2-cyclohexylethyl)-(4Z)-(3-cyclohexylpropylidene)-2-oxetanone, 4-(4-cyclohexylbutylidene)-3-(3-cyclohexylpropyl)-2-oxetanone, 3-(4-cyclohexylbutyl)-4-(5-cyclohexylpentylidene)-2-oxetanone, and mixtures thereof.

Commercially available AKD's are prepared from natural fatty acids containing from 12 to 20 carbon atoms. Due to the variable chain length of the fatty acids used, depending from its source, these industrial AKD's are usually mixtures having a variety of chain lengths. Examples are e.g.
alkyl ketene dimer wax (1840 grade)
molecular formula: C₃₆H₆₈O₂
CAS: 144245-85-2
composition: C₁₆alkyl chain (58.5 to 59.5%) and Cₘalkyl chain (35.5 to 40.5%)
alkyl ketene dimer wax (1865 grade)
molecular formula: C₃₆H₆₈O₂
CAS: 144245-85-2
composition: C₁₆alkyl chain (34.5 to 35.5%) and Cₘalkyl chain (64.5 to 65.5%)

A particular water repellent alkyl ketene dimer is alkyl ketene dimer wax (1865 grade).

The water repellent metal alcoholates are metal C₃₋₈alkyloxides wherein the metal is selected from aluminum, copper, titanium and zircononium. The water repellent metal alcoholates are also referred to as component (II).

Preferred water repellent metal alcoholates are:
tetrabutyl ortho titanate (TBOT) also known as titanium butoxide (CAS 5593-70-4),
aluminum isopropoxide (AIP) (CAS 555-31-7),
zirconium propoxide (ZNP) (CAS 23519-77-9), and
copper isopropoxide (CIP) (CAS 53165-38-1).

As used in the foregoing definitions:
C₃₋₄₀alkyl defines straight and branched chain saturated hydrocarbon radicals having from 3 to 40 carbon atoms such as, for example, propyl, butyl, 1-methylethyl, 2-methylpropyl, pentyl, hexyl, heptyl, octyl, nonyl, and the like;
C₁₂₋₂₀alkyl defines straight and branched chain saturated hydrocarbon radicals having from 12 to 20 carbon atoms;
C₃₋₄₀alkenyl defines straight and branched chain unsaturated hydrocarbon radicals having from 3 to 40 carbon atoms such as, for example, propenyl, butenyl, 2-methyl-propenyl, pentenyl, hexenyl, heptenyl, octenyl, nonenyl, and the like;
C₁₂₋₂₀alkenyl defines straight and branched chain unsaturated hydrocarbon radicals having from 12 to 20 carbon atoms;
C₃₋₈alkyl defines straight and branched chain saturated hydrocarbon radicals having from 3 to 8 carbon atoms such as, for example, propyl, butyl, 1-methylethyl, 2-methylpropyl, pentyl, hexyl, heptyl, octyl, and the like.

This invention concerns compositions comprising a combination of a water repellent alkyl ketene dimer as a component (I) and a water repellent metal alcoholate as a component (II) wherein the ratio by weight of component (I) to component (II) is in respective proportions to provide a synergistic water repellent effect. The synergistic water repellent effect is supported in the examples that demonstrate a synergistic effect on the increase of water droplet absorption time for the combinations of component (I) and component (II) compared to the water droplet absorption time when either component (I) or component (II) is applied individually.

The compositions comprising a combination of a water repellent alkyl ketene dimer as a component (I) and a water repellent metal alcoholate as a component (II) as described in the instant invention impart hydrophobicity to materials whose surfaces have been treated with such compositions. Substances or compositions that impart water repellency to treated materials are referred to as “hydrophobing agents” and materials treated with hydrophobic agents are said to be hydrophobic.

In wood or wooden materials the term “hydrophobicity” refers to the degree to which incursion of water into a wood item is repelled and/or the degree to which the original dimensions of the wood item are conserved after water incursion. The former property is commonly referred to as “water repellency” and the latter as “dimensional stability.”

Compositions comprising these combinations of AKD's and metal alcoholates show unexpectedly high efficacy as hydrophobing compositions when applied to cellulosic substrates, such as wood. As a result, treated wood shows a high resistance to water absorption and is therefore indirectly protected from the disfiguring and degradative action of fungi and algae without using toxic biocides that are currently used for this purpose. The hydrophobing compositions of this invention help to preserve the aesthetic appearance of wood to a greater extent than conventional treatments which often cause unattractive discoloration and hairline fractures and splitting in treated wood.

The relative proportions of the water repellent alkyl ketene dimer as a component (I) and the water repellent metal alcoholate as a component (II) in the compositions of the present invention are those proportions which result in a synergistic water repellent effect, when compared to a composition comprising either a component (I) alone or a component (II) alone. The synergistic water repellent effect can be measured using the droplet absorption time procedure as demonstrated in the Examples 1, 2 and 3. Particular ranges by weight of the water repellent alkyl ketene dimer (I) and the water repellent metal alcoholate (II) are 20:1 to 1:20, or 16:1 to 1:16, or 8:1 to 1:8, or 4:1 to 1:4, or 2:1 to 1:2, or 1:1.

The quantity of each of the water repellent alkyl ketene dimer as a component (I) and the water repellent metal alcoholate as a component (II) in the compositions of the present invention are those quantities which result in a synergistic water repellent effect. In particular it is contemplated that the ready to use compositions of the instant invention comprise a water repellent alkyl ketene dimer as a component (I) in an amount of 0.1% w/v to 40% w/v and a water repellent metal alcoholate as a component (II) in an amount of 0.1% w/v to 40% w/v. The amount of component (I) and component (II) combined ranges from 0.2% w/v to 80% w/v and the relative quantities of component (I) and component (II) individually are such that a synergistic water repellent effect is obtained. Particular quantities of component (I) and component (II) individually are respectively 0.25% w/v, 0.5% w/v, 1.0% w/v, 2.0% w/v, 4.0% w/v, 5.0% w/v and 10.0% w/v and any combination thereof. In many instances the compositions of the present invention to be used directly can be obtained from concentrates, such as e.g. emulsifiable concentrates, suspension concentrates, or soluble concentrates upon dilution with an aqueous or organic solvent, and such concentrates are also covered by the term composition as used in the definitions of the present invention. Such concentrates can be diluted to a ready to use composition in a spray tank or immersion tank shortly before use.

As mentioned above a suspension concentrate is a stable suspension of a combination of a water repellent alkyl ketene dimer (I) and a water repellent metal alcoholate (II) in a fluid intended for dilution with an aqueous or organic solvent before use. An emulsifiable concentrate is a liquid, homogeneous formulation to be applied as an emulsion after dilution in water. A soluble concentrate is a liquid, homogeneous formulation to be applied as a true solution of the active ingredients after dilution in water or in an organic solvent.

The appropriate carrier fluids for use in the compositions of the present invention are any material or substance with which the water repellent alkyl ketene dimer (I) and the water repellent metal alcoholate (II) are formulated in order to facilitate their application to the materials to be treated and/or to facilitate the storage, transport or handling of the compositions without impairing their effectiveness. Such appropriate carriers may be any liquid known in the art of formulation.

Suitable solvents as a carrier are aromatic hydrocarbons, preferably the fractions containing 8 to 12 carbon atoms, e.g. dimethylbenzene mixtures or substituted naphthalenes, phthalates such as dibutyl phthalate or dioctyl phthalate, aliphatic or alicyclic hydrocarbons such as cyclohexane, alcohols and glycols and their ethers and esters, such as ethanol, ethylene glycol, ethylene glycol monomethyl or monoethyl ether, ketones such as cyclohexanone, strongly polar solvents such as N-methyl-2-pyrrolidone, dimethylsulfoxide or dimethylformamide, as well as vegetable oils or epoxidised vegetable oils such as epoxidised coconut oil or soybean oil; or water.

The compositions of the present invention may optionally comprise one or more adjuvants such as dispersants, surfactants, wetting agents, adhesives, thickeners, binders, anti-freeze agents, repellents, colour additives, corrosion inhibitors, water-repelling agents, siccatives, or UV-stabilizers.

The products or materials to be treated with a composition according to the present invention are the surface of any materials that have water absorbing properties such as, but not limited to, wood, wood materials, wood products, woven and non-woven sheeting materials, paper, building materials, gypsum board, and leather.

As used herein, “wood,” “wood material” and “wood products” shall mean all forms of wood, for example, solid wood (such as timber or lumber in the form of logs, beams, planks, sheets and boards), wood composite materials (such as wood fiber board, chip board and particle board) and all products made from wood and wood-composite materials (such as mill frames, decking, siding, siding cladding, roof shingles, utility poles, and railway sleepers).

The compositions of the present invention can be applied to the surface of the materials to be treated by any known technique, for example by dipping, spraying, electrostatic spraying, curtain coating, brush coating, dip coating, flow coating, roll coating and vacuum/pressure treatment methods which utilize pressure difference for penetration of the liquid.

In an embodiment the present invention also relates to the use of a composition comprising a combination of a water repellent alkyl ketene dimer as a component (I) and a water repellent metal alcoholate as a component (II) wherein the ratio by weight of component (I) to component (II) is in respective proportions to provide a synergistic water repellent effect, in the treatment of the surface of materials that have water absorbing properties in order to make it water repellent. Furthermore these compositions comprising a combination of a water repellent alkyl ketene dimer as a component (I) and a water repellent metal alcoholate as a component (II) are of use:
to increase the water repellent properties of the surface of a material whereby said surface is treated with said composition,
to impart water repellent properties to the surface of materials,
for the protection of materials against incursion of water,
for the protection of materials against adherence of water,
to hydrophobe a material or a surface of a material.

The instant invention also relates to a method of hydrophobing a surface of a material by applying a composition comprising a combination of a water repellent alkyl ketene dimer as a component (I) and a water repellent metal alcoholate as a component (II) wherein the ratio by weight of component (I) to component (II) is in respective proportions to provide a synergistic water repellent effect, to said surface, wherein the amount of component (I) and component (II) applied to said surface ranges from 0.1 g/m² to 20 g/m².

The following non-limiting examples illustrate the present invention.

### Experimental Part

### Experiment 1: Droplet Absorption Time

The water repellent properties of the combinations of the present invention were quantified by placing a water droplet, of specific volume, on a treated surface and then the time for complete droplet uptake was measured including a correction for evaporation. This water droplet absorption time test is a sensitive and reproducible method for estimating the hydrophobic efficacy of hydrophobing agents.
Test Model: Scots Pine (Pinus sylvestris L.) sapwood blocks measuring 3×3×3 cm were treated on one crosscut (=transversal) section with 216 μl (=240 ml/m²) of one of the following formulations (for abbreviations, see below), three blocks per treatment.
Test Compound: hexane (untreated control)
1% paraffin
5% paraffin
0.6% TBOT
1.2% TBOT
2.4% AKD
4.8% AKD
0.6% TBOT+2.4% AKD (mixture)
0.6% TBOT+2.4% AKD (separately applied to the same surface)
1.2% TBOT+4.8% AKD (mixture)
   The blocks were then dried for one week at room temperature. Subsequently, a 50 μl water droplet was placed on the treated transversally cut surface and the time (in seconds) was measured until the droplet has entirely disappeared form the surface (light reflection on the water surface no longer detectable with the unaided eye). A polytetrafluoroethylene (PTFE) surface (no water absorption) was used as a positive reference.

### Data Treatment and Synergy Calculation

The disappearance time of the droplets was converted into percentage effect as follows. The droplet disappearance time of the untreated control (being 1 minute in this experiment) was considered as 0% effect and was subtracted from all other values. The droplet disappearance time of an inert surface (in this experiment, but not necessarily so, a PTFE surface), after subtraction of the shortest time, was considered as 100% effect (no absorption, but pure evaporation of water). All other treatments were attributed percentages effect accordingly. The means of three replicates per treatment were used to calculate synergy according to Colby's (1967) method (Colby, S.R. Weeds 1967, 15: 20-22):

$$B = X + Y - \frac{X * Y}{100}$$

Expected “% activity” of combination of A and
where “% activity” is the % lengthening of the absorption time, with the (PTFE—untreated control time) as 100% effect (see above),
X is “% activity” of test compound A, and
Y is “% activity” of test compound B.
When the observed “% activity” is larger than the expected “% activity” (or calculated activity) for a combination of test compound A and test compound B, than synergy has been observed for this combination of A and B.
Compounds: TBOT (titanium (IV) butoxide, CAS 5593-70-4, PID4318/SID6383)
AKD (alkyl ketene dimer CAS 144245-85-2, PID4323/SID6401)
Paraffin (CAS 8002-74-2, PID3131/SID6442)

### Results

Disappearance times for the droplets (mean of three replicates) are listed in Table 1 below, in hh:mm:ss format.

TABLE 1

| Treatment | % test compound | Time (h:m:s) |
|---|---|---|
| Untreated control | 0 | 00:01:01 |
| Paraffin | 1 | 00:37:40 |
| | 5 | 01:12:00 |
| TBOT | 0.6 | 00:59:20 |
| | 1.2 | 01:16:40 |
| AKD | 2.4 | 01:05:00 |
| | 4.8 | 01:20:00 |
| TBOT + AKD (separately applied | 0.6 + 2.4 | 02:14:40 |
| on the same surface) | | |
| TBOT + AKD (mixture) | 0.6 + 2.4 | 02:26:20 |
| | 1.2 + 4.8 | 02:33:20 |
| PTFE (positive reference) | — | 03:14:40 |

Disappearance times for the droplets (mean of three replicates) expressed as percentage activity (=lengthening of disappearance time) are listed in Table 2 below. The measured activity or observed % is listed in column 3. The calculated activity or expected according to Colby's formula is listed in column 4. When the observed activity is larger than the expected activity, the observed % is listed in bold in column 3.

TABLE 2

| | | Observed, | Expected, |
|---|---|---|---|
| | | % droplet | % droplet |
| | | absorption | absorption |
| Treatment | % active | time | time |
| Untreated control | 0 | 0 | — |
| Paraffin | 1 | 19 | — |
| | 5 | 37 | — |
| TBOT | 0.6 | 30 | — |
| | 1.2 | 39 | — |
| AKD | 2.4 | 33 | — |
| | 4.8 | 41 | — |
| TBOT + AKD (separately | 0.6 + 2.4 | 69 | 53 |
| applied on the same surface) | | | |
| TBOT + AKD (mixture) | 0.6 + 2.4 | 75 | 53 |
| | 1.2 + 4.8 | 79 | 64 |
| PTFE (positive reference) | — | 100 | — |

It can be seen that the combinations of TBOT and AKD act synergistically when measuring the droplet absorption time on treated wood crosscut surfaces.

### Experiment 2: Droplet Absorption Time

Test model: Monterey pine (Pinus radiata D. Don) sapwood blocks measuring 50×25×15 mm were treated on one crosscut section (=the transversal section which measures 15×25 mm) with 240 ml/m² of one of the following formulations (for abbreviations, see below), three blocks per treatment.

### Test Compounds:

Hexane (control)
TBOT (titanium (IV) butoxide, CAS 5593-70-4)
AKD (alkyl ketene dimer)

### Test Formulation:

Test formulation for treatment of the sapwood blocks were prepared comprising AKD with a concentration of 0.25% w/v, 0.5% w/v, 1.0% w/v, 2.0% w/v or 4.0% w/v.
Test formulation for treatment of the sapwood blocks were prepared comprising TBOT with a concentration of 0.25% w/v, 0.5% w/v, 1.0% w/v, 2.0% w/v or 4.0% w/v
Test formulations for treatment of the sapwood blocks were prepared comprising a mixture of AKD and TBOT wherein the concentration of AKD and TBOT individually is 0.25% w/v, 0.5% w/v, 1.0% w/v, 2.0% w/v or 4.0% w/v
After treatment with a test formulation, the blocks were then allowed to dry at room temperature. Subsequently, a 100 μl water droplet was placed on the treated transversally cut surface and the time (in minutes) was measured until the droplet had entirely disappeared form the surface (light reflection on the water surface no longer detectable with the unaided eye). A PTFE surface (no water absorption) was used as a positive reference.

### Data Treatment and Synergy Calculation

The disappearance time of the droplets was converted into percentage effect as follows. The droplet disappearance time of the untreated control (being 1 minute in this experiment) was considered as 0% effect and was subtracted from all other values. The droplet disappearance time of an inert surface (in this experiment, but not necessarily so, a PTFE surface), after subtraction of the shortest time, was considered as 100% effect (no absorption, but pure evaporation of water). All other treatments were attributed percentages effect accordingly. The means of three replicates per treatment were used to calculate synergy according to Colby's (1967) method (Colby, S.R. Weeds 1967, 15: 20-22):
Expected “% activity” of combination of A and

$$B = X + Y - \frac{X * Y}{100}$$

where “% activity” is the % lengthening of the absorption time, with the (maximum−minimum time) as 100% effect (see above),
X is “% activity” of test compound A, and
Y is “% activity” of test compound B.
When the observed “% activity” is larger than the expected “% activity” (or calculated % activity) for a combination of test compound A and test compound B, than synergy has been observed for this combination of A and B.

### Results

On the hexane treated negative control blocks, the water droplet took an average time (average of three repeats) of 12.7 minutes to disappear, on the PTFE positive control it took 319.7 minutes on average. The water droplets on the treated wood blocks disappeared between 25.0 and 282.0 minutes.

TABLE 3
Disappearance times of droplets in single and combination
treatments, expressed as percentage activity (=lengthening
of disappearance time). Percentages for combinations are observed
values. Synergistic values (compare with Table 3) are indicated
in bold italics. Hexane control = 0%, PTFE = 100%.
Percentages for combinations are expected values, according
to Colby (1967). Hexane control = 0%, PTFE = 100%.

| | | Observed, | Expected, |
|---|---|---|---|
| | | % droplet | % droplet |
| | | absorption | absorption |
| % w/v AKD | % w/v TBOT | time | time |
| 0 | 0 | 0 | — |
| 0 | 0.25 | 14 | — |
| 0 | 0.5 | 22 | — |
| 0 | 1.0 | 32 | — |
| 0 | 2.0 | 34 | — |
| 0 | 4.0 | 37 | — |
| 0.25 | 0 | 6 | 6 |
| 0.25 | 0.25 | 68 | 19 |
| 0.25 | 0.5 | 72 | 26 |
| 0.25 | 1.0 | 68 | 36 |
| 0.25 | 2.0 | 78 | 38 |
| 0.25 | 4.0 | 67 | 41 |
| 0.5 | 0 | 8 | — |
| 0.5 | 0.25 | * | — |
| 0.5 | 0.5 | 68 | 28 |
| 0.5 | 1.0 | 74 | 37 |
| 0.5 | 2.0 | 74 | 40 |
| 0.5 | 4.0 | 54 | 42 |
| 1.0 | 0 | 14 | — |
| 1.0 | 0.25 | * | — |
| 1.0 | 0.5 | 72 | 32 |
| 1.0 | 1.0 | 76 | 41 |
| 1.0 | 2.0 | * | — |
| 1.0 | 4.0 | * | — |
| 2.0 | 0 | 36 | — |
| 2.0 | 0.25 | 70 | 45 |
| 2.0 | 0.5 | 77 | 50 |
| 2.0 | 1.0 | * | — |
| 2.0 | 2.0 | 81 | 58 |
| 2.0 | 4.0 | * | — |
| 4.0 | 0 | 46 | — |
| 4.0 | 0.25 | 73 | 53 |
| 4.0 | 0.5 | 80 | 57 |
| 4.0 | 1.0 | 84 | 63 |
| 4.0 | 2.0 | 85 | 64 |
| 4.0 | 4.0 | 82 | 66 |

*: not tested

It can be seen that all the combinations of TBOT and AKD act synergistically against the absorption of water by the treated wood crosscut surfaces.

### Experiment 3: Droplet Absorption Time on Non-wood Materials

The water repellency effect of AKD, TBOT and some of their combinations were evaluated on the materials other than wood e.g.: textile, paper, gypsum board, suede leather and floor tiles.
A designated number of samples (three replications) were treated with a test solution using the pipetting method. The water repellency of the treated materials was measured by water droplet method. The results are reported below.

### A) Materials

| | | |
|---|---|---|
| | Specifications | |
| Items | or lot number | Supplier |

Paper

| | | |
|---|---|---|
| Whatman No. 1 | Cat log No: 1001917 | Schleicher & Schuell |
| Filter paper | | |

Textile

| | | |
|---|---|---|
| Non woven (80% | 45 GSM | Grasim industries |
| viscose + 20% polyester) | | |
| 100% cotton absorbent | P.1406013 | Pavitra Group |
| (ORRIS) | | |
| 100% cotton cloth | not applicable | Kadhi bandar |
| Gypsum Board | not applicable | Gyproc India |
| | | Saint-Gobain |
| Suede Leather | Weight 1984 g/m² | Local supplier |
| | and 2.6 mm | |
| | thickness | |
| Clay Floor tiles | not applicable | Bangalore tile |
| (Exterior) | | company |

### B) Synergy Calculation Based on Colby Formula:

Synergy was calculated used the Colby formula as explained in Experiment 1 and Experiment 2. However to allow for easier calculation and to allow for a comparison between the different materials, the droplet absorption time in minutes was first recalculated to a fraction of the longest droplet absorption time observed in the experiment whereby the longest droplet absorption time equals to fraction time=1 and the shortest droplet absorption time equals to fraction time=0. Accordingly all the observed droplet absorption times range between an observed fraction time of 0 to 1.

$$“ Fraction time ” = \frac{droplet absorption time}{\begin{matrix}longest droplet absorption time - \\ shortest absorption droplet time\end{matrix}}$$

$$Expected fraction time = fraction time A + fraction time B - ( fraction time A * fraction time B )$$

When the observed fraction time for a combination of test compound A and test compound B was larger than the expected fraction time for this combination, than synergy was demonstrated.

### C) Water Repellency Testing on Paper

### Test Samples:

The Whatman No. 1 filter paper was cut into rectangular pieces with 50 mm×25 mm dimension.

### Test Solutions:

The test solution was prepared by dissolving the desired quantity of AKD and TBOT in hexane to deliver the designated amount of dry matter (g/m²) to the sample surface (application rate=240 ml/m²). The details of quantity of AKD and TBOT were weighed to prepare 10 ml of test solution is given in the table below.

TABLE 4

| | AKD | TBOT |
|---|---|---|
| Treatment | (g/100 ml) | (g/100 ml) |
| AKD 4.8 g/m² | 2 | — |
| AKD 2.4 g/m² | 1 | — |
| AKD 1.2 g/m² | 0.5 | — |
| TBOT 4.8 g/m² | — | 2 |
| TBOT 2.4 g/m² | — | 1 |
| TBOT 1.2 g/m² | — | 0.5 |
| AKD 2.4 g/m² + TBOT 2.4 g/m² | 1 | 1 |
| AKD 1.2 g/m² + TBOT 1.2 g/m² | 0.5 | 0.5 |

### Treatment Method:

The test samples (3 replications per treatment) were treated uniformly with the 300 μL of the above prepared treatment solution using the micropipette.

### Water Droplet Test:

A droplet of 100 μL of distilled water was placed on the treated surface and the time taken (minutes) for the complete disappearance of the droplet was recorded. The water droplet test was also tested on the untreated filter paper (control) and PTFE. The test results of are given in the table below.

TABLE 5

| Sample | | Time (minutes)* of |
|---|---|---|
| number | Treatment | droplet disappearance |
| 1 | AKD 4.8 g/m² | 269 |
| 2 | AKD 2.4 g/m² | 241 |
| 3 | AKD 1.2 g/m² | 229 |
| 4 | TBOT 4.8 g/m² | 10** |
| 5 | TBOT 2.4 g/m² | 17** |
| 6 | TBOT 1.2 g/m² | 21** |
| 7 | AKD 2.4 g/m² + TBOT 2.4 g/m² | 314 |
| 8 | AKD 1.2 g/m² + TBOT 1.2 g/m² | 294 |
| 9 | Control (untreated) | 0 |
| 10 | PTFE (untreated) | 305 |

*average of 3 replications
**the water droplet was spreading very fast on the surface and was not remaining as a droplet.

Maximum−minimum time=314 minutes=fraction 1.

| | | Droplet | | |
|---|---|---|---|---|
| | | Absorption | Observed | Expected |
| Sample | | Time | (fraction | (fraction |
| number | Treatment | (minutes)* | time) | time) |
| 1 | AKD 4.8 g/m² | 269 | 0.86 | — |
| 2 | AKD 2.4 g/m² | 241 | 0.77 | — |
| 3 | AKD 1.2 g/m² | 229 | 0.76 | — |
| 4 | TBOT 4.8 g/m² | 10 | 0.03 | — |
| 5 | TBOT 2.4 g/m² | 17 | 0.05 | — |
| 6 | TBOT 1.2 g/m² | 21 | 0.07 | — |
| 7 | AKD 2.4 g/m² + | 314 | 1.00 | 0.78 |
| | TBOT 2.4 g/m² | | | |
| 8 | AKD 1.2 g/m² + | 294 | 0.94 | 0.75 |
| | TBOT 1.2 g/m² | | | |
| 9 | Control (untreated) | 0 | — | — |
| 10 | PTFE (untreated) | 305 | — | — |

It can be seen that all the combinations of TBOT and AKD act synergistically against the absorption of water by the treated wood crosscut surfaces.

### D) Water Repellency Testing on Textile

Test Samples: the following textile samples were taken for testing

| Sample | | Dimension, | Thickness, | Weight, |
|---|---|---|---|---|
| No. | Test Specimens | mm² | mm | g |
| 1 | Non-woven | 50 × 25 | 0.45 | 0.20 |
| | (80% viscose 20% | | | |
| | polyester) | | | |
| 2 | 100% cotton absorbent | 50 × 25 | 0.25 | 0.10 |
| 3 | 100% cotton cloth (Khadhi) | 50 × 25 | 0.20 | 0.15 |

### Test Solutions:

The test solution was prepared by dissolving the desired quantity of AKD and TBOT in hexane to deliver the designated amount of dry matter (g/m²) to the sample surface. The details of quantity of AKD and TBOT weighed to prepare 10 ml of test solution are given in the table below.

| | AKD | TBOT |
|---|---|---|
| Treatment | (g/100 ml) | (g/100 ml) |
| AKD 4.8 g/m² | 1 | — |
| AKD 2.4 g/m² | 0.5 | — |
| AKD 1.2 g/m² | 0.25 | — |
| TBOT 4.8 g/m² | — | 1 |
| TBOT 2.4 g/m² | — | 0.5 |
| TBOT 1.2 g/m² | — | 0.25 |
| AKD 2.4 g/m² + TBOT 2.4 g/m² | 0.5 | 0.5 |
| AKD 1.2 g/m² + TBOT 1.2 g/m² | 0.25 | 0.25 |

*Application rate: as it was not possible to apply and spread uniformly the treatment solution with the 240 ml/m² application rate, the 480 ml/m² application rate was adapted to deliver the desired dry matter.

### Treatment Method:

The test samples (3 replications per treatment) were treated uniformly with the 600 μL of the above prepared treatment solution using the micropipette.

### Water Droplet Test:

The 100 μL of distilled water was placed on the treated surface and the time taken (Minutes) for the complete disappearance of the droplet was recorded. The water droplet test was also tested on the untreated textile samples (control) and Teflon. The test results of are given in the table below.

Nonwoven (80% viscose 20% polyester)

| | | Droplet | | |
|---|---|---|---|---|
| | | Absorption | Observed | Expected |
| Sample | | Time | fraction | fraction |
| No. | Treatment | (minutes) | time | time |
| 1 | AKD 4.8 g/m² | 334 | 0.88 | — |
| 2 | AKD 2.4 g/m² | 315 | 0.83 | — |
| 3 | AKD 1.2 g/m² | 280 | 0.74 | — |
| 4 | TBOT 4.8 g/m² | 232 | 0.61 | — |
| 5 | TBOT 2.4 g/m² | 224 | 0.59 | — |
| 6 | TBOT 1.2 g/m² | 227 | 0.60 | — |
| 7 | AKD 2.4 g/m² + | 380 | 1.00 | 0.93 |
| | TBOT 2.4 g/m² | | | |
| 8 | AKD 1.2 g/m² + | 369 | 0.97 | 0.89 |
| | TBOT 1.2 g/m² | | | |
| 9 | Control (Untreated) | 0 | — | — |
| 10 | PTFE (Untreated) | 322 | — | — |

*average of 3 replications

100% cotton absorbent

| | | Droplet | | |
|---|---|---|---|---|
| | | Absorption | Observed | Expected |
| Sample | | Time | fraction | fraction |
| No. | Treatment | (minutes) | time | time |
| 1 | AKD 4.8 g/m² | 342 | 0.87 | — |
| 2 | AKD 2.4 g/m² | 320 | 0.82 | — |
| 3 | AKD 1.2 g/m² | 292 | 0.75 | — |
| 4 | TBOT 4.8 g/m² | 252 | 0.64 | — |
| 5 | TBOT 2.4 g/m² | 266 | 0.68 | — |
| 6 | TBOT 1.2 g/m² | 249 | 0.64 | — |
| 7 | AKD 2.4 g/m² + | 391 | 1.00 | 0.94 |
| | TBOT 2.4 g/m² | | | |
| 8 | AKD 1.2 g/m² + | 375 | 0.96 | 0.91 |
| | TBOT 1.2 g/m² | | | |
| 9 | Control (Untreated) | 0 | — | — |
| 10 | PTFE (Untreated) | 322 | — | — |

*average of 3 replications

100% cotton cloth

| | | Droplet | | |
|---|---|---|---|---|
| | | Absorption | Observed | Expected |
| Sample | | Time | fraction | fraction |
| No. | Treatment | (minutes) | time | time |
| 1 | AKD 4.8 g/m² | 328 | 0.85 | — |
| 2 | AKD 2.4 g/m² | 307 | 0.80 | — |
| 3 | AKD 1.2 g/m² | 273 | 0.71 | — |
| 4 | TBOT 4.8 g/m² | 227 | 0.59 | — |
| 5 | TBOT 2.4 g/m² | 219 | 0.57 | — |
| 6 | TBOT 1.2 g/m² | 221 | 0.58 | — |
| 7 | AKD 2.4 g/m² + | 384 | 1.00 | 0.91 |
| | TBOT 2.4 g/m² | | | |
| 8 | AKD 1.2 g/m² + | 372 | 0.97 | 0.88 |
| | TBOT 1.2 g/m² | | | |
| 9 | Control (Untreated) | 0 | — | — |
| 10 | PTFE (Untreated) | 322 | — | — |

*average of 3 replications

### E) Water Repellency Testing on Gypsum Board

### Test Samples:

The Gypsum board was cut into rectangular pieces with 50 mm×25 mm×15 mm dimension and the same was used for the experiment.

### Test Solutions:

The test solution was prepared by dissolving the desired quantity of AKD and TBOT in hexane to deliver the designated amount of dry matter (g/m²) to the sample surface. The details of quantity of AKD and TBOT weighed to prepare 10 ml of test solution is given in the table below

| | AKD | TBOT |
|---|---|---|
| Treatment | (g/100 ml) | (g/100 ml) |
| AKD 4.8 g/m² | 2 | — |
| AKD 2.4 g/m² | 1 | — |
| AKD 1.2 g/m² | 0.5 | — |
| TBOT 4.8 g/m² | — | 2 |
| TBOT 2.4 g/m² | — | 1 |
| TBOT 1.2 g/m² | — | 0.5 |
| AKD 2.4 g/m² + TBOT 2.4 g/m² | 1 | 1 |
| AKD 1.2 g/m² + TBOT 1.2 g/m² | 0.5 | 0.5 |

* application rate = 240 ml/m²

### Treatment Method:

The test samples (3 replications per treatment) were treated uniformly with the 300 μL on longitudinal surface (50 mm×25 mm), 180 μL on tangential side (50 mm×15 mm) and 90 μL on cross sectional area (25 mm×15 mm) using the micropipette.

### Water Droplet Test:

The 100 μL of distilled water was placed on the cross sectional area (25 mm×15 mm) and the time taken (Minutes) for the complete disappearance of the droplet was recorded. The water droplet test was also tested on the untreated gypsum board (control) and PTFE. The test results of are given in the table below.

| | | Time |
|---|---|---|
| SI. No | Treatments | (Min)* |
| 1 | AKD 4.8 g/m² | 31 |
| 2 | AKD 2.4 g/m² | 23 |
| 3 | AKD 1.2 g/m² | 10 |
| 4 | TBOT 4.8 g/m² | 0** |
| 5 | TBOT 2.4 g/m² | 0** |
| 6 | TBOT 1.2 g/m² | 0** |
| 7 | AKD 2.4 g/m² + TBOT 2.4 g/m² | 243 |
| 8 | AKD 1.2 g/m² + TBOT 1.2 g/m² | 215 |
| 9 | Control (Untreated) | 0 |
| 10 | PTFE (Untreated) | 314 |

*average of 3 replications
**The specimens treated with TBOT didn't show any repellency as the water droplet was spreading very fast on the surface and was not remaining as a droplet.

| | | Droplet | | |
|---|---|---|---|---|
| | | Absorption | Observed | Expected |
| | | Time | fraction | fraction |
| Sample | Treatment | (minutes) | time | time |
| 1 | AKD 4.8 g/m² | 31 | 0.10 | — |
| 2 | AKD 2.4 g/m² | 23 | 0.07 | — |
| 3 | AKD 1.2 g/m² | 10 | 0.03 | — |
| 4 | TBOT 4.8 g/m² | 0** | 0.00 | — |
| 5 | TBOT 2.4 g/m² | 0** | 0.00 | — |
| 6 | TBOT 1.2 g/m² | 0** | 0.00 | — |
| 7 | AKD 2.4 g/m² + | 243 | 0.77 | 0.07 |
| | TBOT 2.4 g/m² | | | |
| 8 | AKD 1.2 g/m² + | 215 | 0.68 | 0.03 |
| | TBOT 1.2 g/m² | | | |
| 9 | Control (Untreated) | 0 | 0.00 | — |
| 10 | PTFE (Untreated) | 314 | 1.00 | — |

*average of 3 replications

1. A composition comprising a combination of a water repellent alkyl ketene dimer as a component (I) and a water repellent metal alcoholate as a component (II) wherein the ratio by weight of component (I) to component (II) is in respective proportions to provide a synergistic water repellent effect.

2. The composition according to claim 1 wherein the water repellent alkyl ketene dimer is of formula (I) 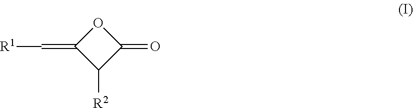
wherein R¹ and R² are each independently selected from C₃₋₄₀alkyl and C₃₋₄₀alkenyl.

3. The composition according to claim 2 wherein R¹ and R² are each independently selected from C₁₂₋₂₀alkyl and C₁₂₋₂₀alkenyl.

4. The composition according to claims 1 wherein the water repellent metal alcoholate (II) is a metal C₃₋₈alkyloxide wherein the metal is selected from aluminum, copper, titanium and zircononium.

5. The composition according to claim 4 wherein the water repellent metal alcoholate (II) is selected from tetrabutyl ortho titanate, aluminum isopropoxide, zirconium propoxide and copper isopropoxide.

6. The composition according to claim 1 wherein the water repellent alkyl ketene dimer is alkyl ketene dimer wax (1865 grade) and the water repellent metal alcoholate (II) is tetrabutyl ortho titanate.

7. The composition according to claim 1 wherein the ratio by weight of component (I) to component (II) ranges from 20:1 to 1:20.

8. The combination according to claim 7 wherein the ratio by weight of component (I) to component (II) ranges from 16:1 to 16:1, or from 8:1 to 1:8, or from 4:1 to 1:4 or from 2:1 to 1:2.

9. The combination according to claim 1 having an amount of component (I) ranging from 0.1% w/v to 40% w/v and an amount of component (II) ranges from 0.1% w/v to 40% w/v wherein the relative quantities of component (I) and component (II) individually are such that a synergistic water repellent effect is obtained.

10. A method of treating the surface of material using a combination as claimed in claim 1 to make the surface water repellent.

11. A method of treating the surface of material using a combination as claimed in claim 1 to increase the water repellent properties of the surface of a material that has water absorbing properties.

12. A method of treating the surface of material using a combination as claimed in claim 1 for the protection against incursion, or adherence, of water of material that have water absorbing properties.

13. A method of hydrophobing a surface of a material that has water absorbing properties by applying a composition as claimed in claim 1, to said surface, wherein the amount of component (I) and component (II) applied to said surface ranges from 0.1 g/m² to 20 g/m².

14. A method of treating the surface of material using a combination as claimed in claim 1 having an amount of component (I) and component (II) in combined ranges from 0/2% w/v to 80% w/v and the relative quantities of component (I) and component (II) individually are such that a synergistic water repellent effect is obtained.
